(19) United States
(12) Patent Application Publication
(10) Pub. No.: US 2006/0023225 A1
(43) Pub. Date: Feb. 2, 2006

(54) Microscope and method of measurement of a surface topography

(75) Inventors: Helmut Tobben, Braunschweig (DE); Dirk-Roger Schmitt, Braunschweig (DE); Gabriele Ringel, Braunschweig (DE)

Correspondence Address: SALTER & MICHAELSON;THE HERITAGE BUILDING, 321 SOUTH MAIN STREET, PROVIDENCE, RI, 029037128, US

(73) Assignee: Carl Zeiss

(21) Appl. No.: 11/199,753

(22) Filed: Aug. 31, 2005

Related U.S. Application Data
(63) Continuation of application No. 10/311,008, filed on Feb. 19, 2003, now abandoned.

(51) Int. Cl. G01B 11/02

(52) U.S. Cl. 356/497

(57) ABSTRACT

The invention relates to a microscope and a method for measuring the surface topography of a workpiece in a quantitative and optical manner. The invention includes a differential interference contrast microscope embodiment according to Nomarski, comprising a light source, a polariser, a changeable Nomarski prism and an analyser. The light source has a narrow frequency spectrum and/or is provided with a special filter having a narrow frequency spectrum; and the microscope is provided with a phase displacement interferometry evaluation unit.

### 1. TECHNICAL FIELD

The invention relates to a microscope and a method for the quantitative optical measurement of the topography of the surface of a work piece.

### 2. BACKGROUND OF RELATED ART

Microscopes are not only used for viewing structures of small area more closely, but have also been used for a long time for the quantitative characterisation of surfaces.

Reflected light interference microscopes are very easy to handle and operate without contact with the work piece, i.e. in an absolutely non-destructive manner. However, usual incident light techniques (bright field, dark field) are not suitable for examining the topographies of surfaces, since they are dependent on differences in amplitude on the surface. However, a surface topography does not generate any differences in amplitude, merely relative phase differences in the reflected wavefront.

However, these phase differences may be converted into differences in amplitude by means of double-beam interference. In commercially available microscopes for the quantitative characterisation of surface topographies, different configurations are used for such double-beam interferometry. In these cases, the principle of image formation is the same in spite of the different arrangements of the two component beams: the surface topography generates a phase difference between the two component beams, which is converted into differences in amplitude by the subsequent superposition. As a result of a computer-controlled displacement of the phase position, the surface topography can then be reconstructed from the interference pattern. This is referred to as so-called phase shift interferometry.

In these double-beam interferometers measurements always occur relative to a reference surface. On the one hand, this results, most disadvantageously, in a very high sensitivity of these measurement devices with respect to vibrations. Moreover, the measurement precision itself is also restricted by the roughness of the reference surface.

### SUMMARY

Consequently, the object of the invention is to propose a microscope and a method for the quantitative optical measurement of the topography of the surface of a work piece, which is less sensitive to vibration and also assures higher measurement precision, where possible.

This object is achieved by a microscope for the quantitative optical measurement of the topography of the surface of a work piece, characterised by a Nomarski-type differential interference contrast microscope having a light source, a polariser, a Nomarski prism and an analyser, where the light source has a narrow frequency spectrum and/or the light source is equipped with a spectral filter with a narrow frequency spectrum. A device for reproducible phase shifting is also provided, and a phase shifting interferometry evaluation unit is preferably provided.

In the case of a method of quantitative optical measurement of the topography of a surface of a work piece, this object is achieved in that a Nomarski-type differential interference contrast method is conducted, where light from a narrow frequency spectrum is used and an evaluation is implemented by phase shifting interferometry.

The problems encountered in the prior art are surprisingly solved with such a microscope and such a method, although a Nomarski differential interference contrast microscope setup has been known for many years and is described in specialist literature.

In contrast to double-beam interferometers, the microscope setup described herein generates an image of the surface topography visible to the human eye. However, the Nomarski microscope has always been used hitherto only for the qualitative assessment of surface topographies. The great advantage of Nomarski microscopy is that the corresponding method does not require any reference surface. As a result, Nomarski microscopes are not sensitive to vibration. Various proposals have already been made for the use of Nomarski microscopes for evaluations; for example, by John S Hartman, Richard L Gordon and Delbert L Lessor in “Applied Optics” (1980) 2998 to 3009 or M J Fairlie, J G Akkermann, R S Timsit in “SPIE 749” (1987) 105 to 113 or also in DE 41 92 191 C1 and DE 42 42 883 C2. These approaches respectively work to convert the formed image into grey levels and then conduct a quantitative evaluation of these grey levels.

The invention deviates from this conventional conception of image processing. Instead, it provides a possibility of phase shift interferometry for the Nomarski microscope setup. This occurs by providing for reproducible phase shifting, in particular by the Nomarski prism being adjustable. The term “adjustable” should be understood to mean, in particular, that the prism is itself displaceable or that, alternatively, a phase shift can also be achieved with a fixed prism by means of a λ/4 plate and a rotatable analyser. A direct quantitative approach to direct assessment of surface topographies using a Nomarski microscope results from this.

An important aspect of the device for phase shifting is the fact that the phase shift is dependent on the polarisation state of the light. Corresponding devices comprising double-refracting crystals are also referred to in the specialist literature as compensators or phase shifters. In principle, every double-refracting medium is suitable for forming such a phase shifter.

A phase shifting interferometry technique can then be performed in the evaluation unit utilising the advantages of a Nomarski microscope with its high resolution, lack of sensitivity to vibration and qualitative surface viewing possibilities.

The evaluation unit preferably has an electro-optical image converter. This can, for example, be a camera with electronic signal output or a CCD sensor.

It is particularly preferred if the rotational axis of the support of the work piece 10 is centred relative to the optical axis of the microscope. In this case, the centring should occur in particular with a precision below the limit resolution of the microscope. The rotational axis is then centred with a precision, which does not reveal any deviations in the centre point of the work piece during a rotation of the work piece and the combination used of imaging system and evaluation unit, so that measurable deviations do not occur.

Alternatively, in the case of an adjustment which is not adequately precise, the displacement can be determined by image comparison processes and can be determined and corrected in the subsequent evaluation process.

The result is a novel, high-resolution, extremely reliable and fast measurement instrument for the determination of rough areas. Surface topographies can be quantitatively characterised quickly and reliably as well as precisely.

Moreover, all the known measurement methods using double-refracting interferometers are not able to permit direct qualitative assessment of the topography, of the surface with the aid of the human eye. However, the present invention does exactly that as a considerable additional advantage i.e., before the actual measurement the user of the microscope is already able to make an image of the results to be expected. It is, therefore, possible to perform a direct qualitative assessment by means of the human eye before measurement.

The method used for evaluating the Nomarski image is phase measurement interferometry (PMI), such as that described, for example, in another context by Katerine Creath “Comparison of Phase-Measurement Algorithms” in SPIE vol. 680, Surface Characterization and Testing (1986)/19 and “An Introduction to Phase-Measurement Interferometry”. June 1987, a company paper of the WYKO CORPORATION. PMI is used to determine the form of a wavefront in interferometers by phase modulation of a reference beam, recording the interference fringes or circular interference fringes, and subsequent evaluation. A great advantage is that as a result of the evaluation algorithm, the result is not dependent on the background brightness (or uneven brightness distribution). There are various approaches with this method for determining the phase information and subsequent calculation of the surface shape of the work piece. What is characteristic of this method is that it was developed for the evaluation of interference fringes or circular fringes in double-beam interferometers or similar systems. Examples for the quantitative evaluation of such interferometer information are given, inter alia, in the above literature by Creath.

The present invention uses this method with surprising success for the evaluation of the image generated by the Nomarski microscope, and this is not an interference fringe pattern typical for an interferometer. Because of the characteristics of the Nomarski image, for the generation of an image of the surface topography visible to the human eye, it has not been obvious hitherto to quantitatively evaluate this image using a method which was developed for interference fringes. The invention uses this method with surprising success and with it for the first time allows quantitative determination of the surface topography from a Nomarski microscope image in which case, for example, influences of an inhomogeneous illumination or a sample surface that is not oriented exactly perpendicular to the optical axis must be eliminated in the evaluation algorithm and need not be compensated by other difficult to handle methods (for example, recording of a reference brightness, recording of a reference surface), as is necessary with other published or known qualitative evaluations of the Nomarski image.

In the preferred phase measurement interferometry (PMI) technique to be used, the phase between the two image-forming component beams is shifted by displacement of the Nomarski prism or alternatively by rotation of the analyser with an additionally inserted λ/4 plate in steps between 0 and π, preferably by π/2, and the intensity is measured in consecutive measurements, or the phase is continuously shifted and the intensity integrated. Generally, N measurements of intensity (as integral or individual measurement) are taken over the viewing field, when the phase is shifted. For this, it is expedient that the phase shifter is calibrated beforehand. At least N=3 measured values are necessary. Various evaluation methods are known, including that of the four-bucket technique (N=4), the three-bucket technique (N=3), the Carré technique, the averaging three-and-three technique, the five-bucket technique (N=5) or other related or completely different techniques, in which case the techniques are all generally used for the evaluation of interference fringes or circular fringes, but not for the evaluation of images of a Nomarski microscope. The invention shifts the use of these methods to a Nomarski microscope. By way of example, the results on application of the four-bucket (N=4) technique are explained below, other or modified methods, which are based on phase shifting and were developed for the evaluation of interference fringes, are equally suitable and are part of the invention.

[Various preferred embodiments of the invention are characterised in the sub-claims.]

### BRIEF DESCRIPTION OF THE DRAWINGS

It should be understood that the drawings are provided for the purpose of illustration only and are not intended to define the limits of the invention. The foregoing and other objects and advantages of the embodiments described herein will become apparent with reference to the following detailed description when taken in conjunction with the accompanying drawings in which:

FIG. 1 is a schematic representation of a microscope according to the invention;

FIG. 2 is a perspective representation of a module as part of the microscope according to the invention;

FIG. 3 is a general view of a setup with evaluation unit;

FIG. 4 shows the image intensity in dependence on the prisma position;

FIGS. 5a-d are representations of the measurement principle in the case of phase shifting interferometry;

FIG. 6 is a 3D representation of the topography of a surface;

FIGS. 7a and 7b show comparison curves of various measurement methods;

FIGS. 8a-d shows various representations of measurement results; and

FIG. 9 is a representation of the repetitive accuracy.

### DETAILED DESCRIPTION OF THE ILLUSTRATIVE EMBODIMENTS

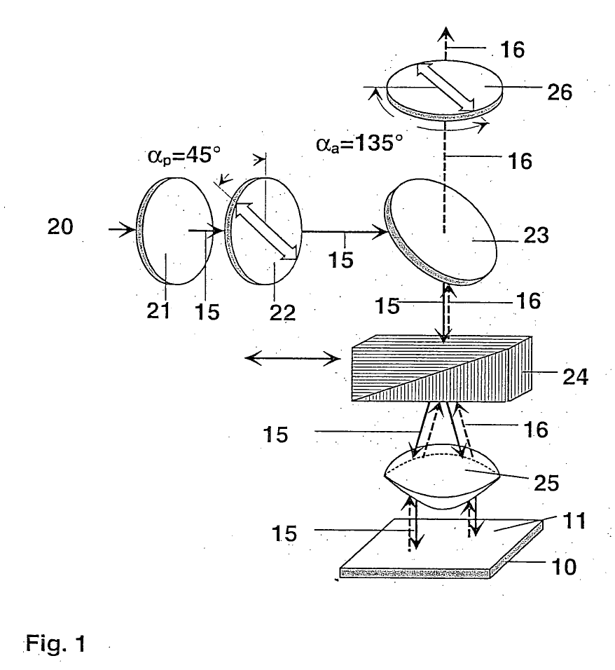

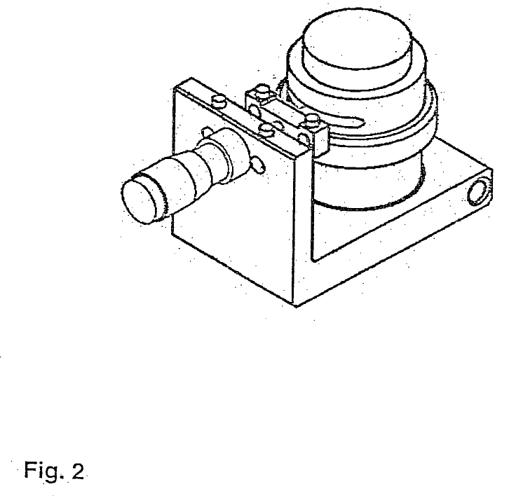

FIG. 1 schematically shows the setup of a microscope according to the invention. The overall structure of the microscope is similar to a Nomarski setup. A work piece 10 or the topography of the surface 11 of this work piece 10 is to be examined. The optical path is reproduced by initially incident light 15 and then light 16 reflected by the surface 11 of the work piece 10.

The starting point is a light source 20, which in the present embodiment is a white light source. The light preferably falls through a spectral filter 21 with a narrow frequency spectrum. The light of this frequency spectrum then strikes a polariser 22 and is linearly polarised there. The light then passes to a partially transparent, in this case semi-transparent, mirror 23, which is directed into the optical path in such a manner that it deflects the incident light from the light source 20 in the direction of the surface 11 of the work piece 10, in the present embodiment. The work piece is frequently also referred to as a sample.

From the mirror 23, the light falls onto the Nomarski prism 24, a double-refracting prism. The prism 24 preferably splits the light into two orthogonally plane polarised component beams, which strike the surface 11 of the work piece 10 after passing through an objective lens 25 which preferably includes a slight lateral displacement. On reflection on the surface 11 of the work piece 10, the two component beams undergo a relative phase shift to each other because of the topography of the surface 11. The beams of the reflected light 16 are now superposed again in the Nomarski prism 24 after passing through the objective lens 25 again.

The beams pass further through the semi-transparent mirror 23 to an analyser 26, in which a selection of a common polarisation component occurs. The component beams are now capable of interference again.

The interference pattern resulting in this way contains information concerning the differential changes in elevation in the direction of the beam displacement.

It has been determined that rough areas on surfaces in the order of magnitude of 0.05 nm can be made visible with such a microscope. The interference pattern constitutes a good image of the surface 11 of the work piece 10 with two small limitations. Firstly, it is not a direct image of the surface topography, but merely a gradient image which depicts changes in elevation not elevations itself.

Secondly, these changes in elevation are only visible in the shear direction.

The local image intensity is determined by the relative phase difference between the two plane polarised component beams. For a phase difference χ the intensity in the image plane results as:

$$I = {I}_{max} \{ Q + \frac{1}{2} [ 1 - Q ] \cdot [ 1 - cos ( χ ) ] \} . \qquad ( 1 )$$

The magnitude Iₘₐₓ denotes the maximum intensity to be observed and the magnitude Q the optical losses within the microscope. For a specific optical system, these losses constitute a constant, whereas the maximum intensity is dependent on the reflectivity of the observed surface. The phase shift χ comprises two components, a component α, which is dependent on the surface topography, and a further component β, which results from the position and the characteristics of the Nomarski prism:
χ=α+β (2)

The amount of phase shift β changes linearly with the shift x of the prism in the shear direction so that

$$β = {β}_{0} + \frac{ⅆ β}{ⅆ x} x \qquad ( 3 )$$

applies. In this equation β₀ denotes the phase shift at the location x=0 and dβ/dx denotes the gradient of the phase shift in the shear direction.

In order to determine the gradient of the phase shift in the shear direction, a calibration of the system is recommended, which will be explained below. Besides the phase shift the component beams undergo opposed changes in their directions of propagation which leads to local splitting of the light spots with the spacing Δs on the sample surface. The phase shift caused by the prism changes the background brightness of the entire interference pattern, while the surface topography leads to regional modulations of the image intensity. If virtually perpendicular light incidence onto the surface is worked from, then a difference in elevation Δz in the shear direction between the two component beams leads to a phase shift α of

$$α = \frac{4 π}{λ} Δ z \qquad ( 4 )$$

Thus, the phase shift α is proportional to the change in elevation Δz in the shear direction. Hence, it follows for the intensity distribution in the interference pattern that

$$I = {I}_{max} \{ Q + \frac{1}{2} [ 1 - Q ] \cdot [ 1 - cos ( \frac{4 π}{λ} Δ z + {β}_{0} + \frac{ⅆ β}{ⅆ x} x ) ] \} \qquad ( 5 )$$

To obtain quantitative information concerning the surface topography from such an intensity distribution alone, it would be necessary to assign the measured intensities to the corresponding changes in elevation via a suitable calibration. However, this method is extremely complex and unreliable.

According to the present invention the phase shift interferometry technique is now used. This technique enables the phase a to be determined directly. Conventionally, various relative phase shifts are set between the measurement and the reference beams in such methods in a different context, and then the intensity distribution is determined.

The phase shifts are set by the change in the course of the beam in the reference optical path. For this, the reference surface is shifted along the optical axis with a piezoelectric ceramic. The component a at the phase shift X, which results from the surface topography, is calculated from the set of intensity distributions thus obtained.

However, in the invention in the embodiment shown in FIG. 1, a displaceable Nomarski prism 24 is integrated into a reflected light interference microscope. In the shown embodiment the optics of the microscope are sufficiently free from double refraction and polarisers 22 or analysers 26 can be integrated into the course of the illuminating beam and viewing beam.

In the microscope the relative phase shift between the two beams is generated in a very simple manner by displacement of the Nomarski prism 24 in the shear direction. A set of at least three intensity distributions is necessary, since equation (5) contains three unknown magnitudes: the maximum intensity Iₘₐₓ, the optical losses Q; and the difference in elevation Δz. In practice, however, the use of four intensity distributions has proved expedient. These four intensity distributions I₁, I₂, I₃ and I₄ with phase shifts δᵢ of 0, π/2, π and 3/2π are described by equation (6):

$${I}_{i} = {I}_{max} \{ Q + \frac{1}{2} [ 1 - Q ] \cdot [ 1 - cos ( α + {β}_{i} ) ] \} , {β}_{i} = {β}_{0} + \frac{ⅆ β}{ⅆ x} {x}_{i} \qquad ( 6 )$$

The phase βᵢ can be set by the displacement of the Nomarski prism 24 in the shear direction by the section xᵢ. The phase shift α can then be easily determined from these four intensity distributions:

$$α ( x , y ) = {tan}^{- 1} [ \frac{{I}_{4} ( x , y ) - {I}_{2} ( x , y )}{{I}_{1} ( x , y ) - {I}_{3} ( x , y )} ] \qquad ( 7 )$$

With these methods determination of the phase shift α only occurs to integral multiples of π. Because of the periodicity of the angle functions the values for α are folded in the range between −π and π. Therefore, unfolding must be conducted for full determination of the phase shift. For this, multiples of π are added or subtracted until the phase difference between two adjacent image points is smaller than π/2. However, the prerequisite for this is that the difference in elevation between two adjacent image points does not cause any phase shift greater than π/2. If the phase shift is determined in this way, then the gradient of the surface topography ∂z/∂x results as:

$$\frac{\partial z ( x , y )}{\partial x} = \frac{λα ( x , y )}{4 π \cdot Δ s} \qquad ( 8 )$$

By numeric integration in the shear direction a line profile of the surface topography in x direction may be prepared from this:

$${z}_{x} ( {x}_{i} , {y}_{j} ) = {\sum }_{k = 0}^{i} Δ x \frac{{λα}_{x} ( {x}_{k} , {y}_{j} )}{4 πΔ s} + {c}_{j} \qquad ( 9 )$$

The x indices should clarify that only surface structures in x direction are determined.

If the user orients the sample under the microscope in such a way that the structures of interest run perpendicular to the shear direction, informative results are given in spite of this limitation.

FIG. 2 shows a preferred embodiment of the invention. This is a module with a Nomarski prism 24. It is configured so that it can be installed into an existing microscope in place of a conventional objective lens. The prism can be displaced in the shear direction so that a relative phase shift can be set between the two component beams. The displacement is performed manually with a micrometer screw or micrometer caliper. Depending on the embodiment, it can also be performed automatically with a stepping motor, a piezoelectric adjuster or similar. The prism with the displacement mechanism can also be rotated around the optical axis to adapt it to the geometry of the microscope. Moreover, it is also possible to perform the phase shift with a fixed prism by inclusion of a λ/4 plate and rotation of the analyser. A computer for automatic control of the phase shift is connected to the module.

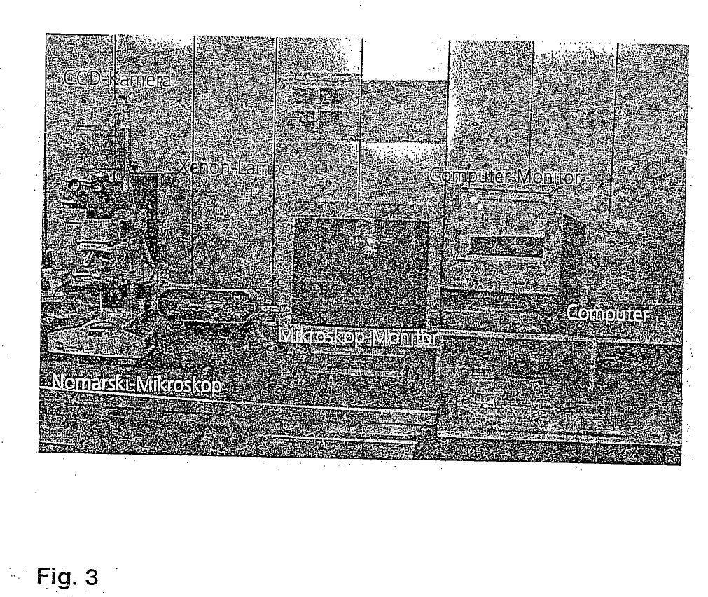

FIG. 3 shows how a commercially available microscope could be set up according to the invention. The module is installed between the objective lens and lens holder in accordance with FIG. 1. Two polarisation filters are additionally installed.

Measurement of the intensity distribution is achieved with a sensor 27, e.g. with a high-resolution CCD measurement camera. The camera is rotatable around the optical axis of the microscope so that the shear direction can be brought into conformity with the direction of the lines or slits of the camera. The control unit of the camera is connected to an image storage unit via a digital interface. This image storage unit is integrated into an evaluation unit 30 with a computer. The digital processing and evaluation of the Nomarski pictures are done by the computer. In FIG. 3 the left half of the picture shows the microscope with the module according to the invention including xenon lamp and CCD camera, the right half of the picture shows the evaluation unit with an image processing system, which has a computer with built-in image storage unit and two monitors.

The data of the CCD chip should preferably be selected so that the lateral resolution is restricted by the optical resolution of the microscope.

The vertical resolution is preferably restricted by the signal-to-noise ratio of the detector. However, it is not possible to specify an absolute limit value, since no suitable depth adjustment normals are available for its determination. Therefore, the vertical resolution capability is characterised relative to the so-called repetitive accuracy. For this, two identical measurements are conducted on a surface and the surface topographies determined thereby are subtracted from one another. The mean square roughness of this subtraction constitutes a dimension for the vertical resolution limit. This means that a depth adjustment normal can in fact no longer be resolved at this depth since the signal-to-noise ratio amounts to one.

The vertical dynamic range is limited to three factors: firstly, the difference in elevation between adjacent image points must not cause any phase difference greater than π/2. This means that the difference in elevation between adjacent image points must not be greater than λ/4. Otherwise the phase shifting method delivers false results. If this criterion is met, then the maximum difference in elevation still to be measured is restricted by the depth of field of the microscope.

To demonstrate the practical use of the invention, a depth adjustment normal as well as various BK7 surfaces are examined. The quantitative results obtained in this case are shown below.

The present invention will be further illustrated by the following examples, which are intended to be illustrative in nature and are not to be considered as limiting the scope of the invention.

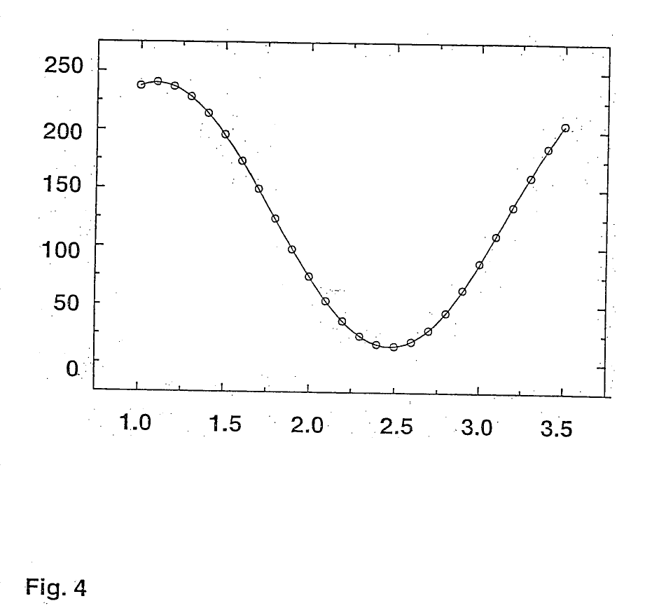

Firstly, the optical components of the Nomarski microscope (polariser 22, analyser 26 and Nomarski prism 24) were adjusted in accordance with FIG. 1. The CCD sensor was oriented so that the shear direction of the microscope coincides with the lines of the sensor. The depth adjustment normal served to calibrate the relative phase shift between the two component beams, which is caused by the Nomarski prism. Except for the seams, it is distinguished by a very slight roughness, which in the Nomarski microscope leads to a correspondingly uniform brightness. The image brightness was recorded as a function of the prism position. For this, the prism was displaced over an area of 2.5 mm in steps of 0.1 mm. At each measurement point the intensity distribution was averaged at 100 ms exposure time and 0 dB amplification over 16 individual images. The background brightness was calculated by averaging over the entire surface of the CCD sensor. The brightness in grey levels is plotted in FIG. 4 as a function of the prism position, which is given to the right in mm.

The measurement points in FIG. 4 show this measured brightness curve in dependence on the prism position and the non-linear regression through equation (5). The conformity between the measured values and the non-linear regression is very good. The non-linear regression provides a maximum intensity Iₘₐₓ of 240 grey levels with losses Q of 0.06. For the phase shift gradients dρ/dx, 2.28 rad/mm result with a start value β₀ of 0.66 rad. While Iₘₐₓ and Q are dependent on the reflectivity of the examined surface, dβ/dx may be randomly selected independently of the properties of the surface concerned and β₀.

The phase shifting gradient dβ/dx constitutes the relevant magnitude for phase shifting interferometry. Because this is known, the phase shift between the two component beams can be adjusted to any desired values between about 0 and 2π. Thus, the necessary preconditions are created in order to quantitatively determine surface topographies using phase shifting interferometry. The measurement principle will be explained below using the example of a step height standard of 98.5 nm.

The step height standard was oriented under the microscope in such a way that the 98.5 nm step is oriented perpendicular to the shear direction. Four interference patterns were then taken with relative phase shifts βᵢ of 0, π/2, π and 3/2π between the two component beams. For a desired phase shift by π/2 the preceding calibration provides a necessary shift of the prism position by 0.69 mm. The representation of the results is restricted to an area of a maximum of 512×512 image points by the 3D software used.

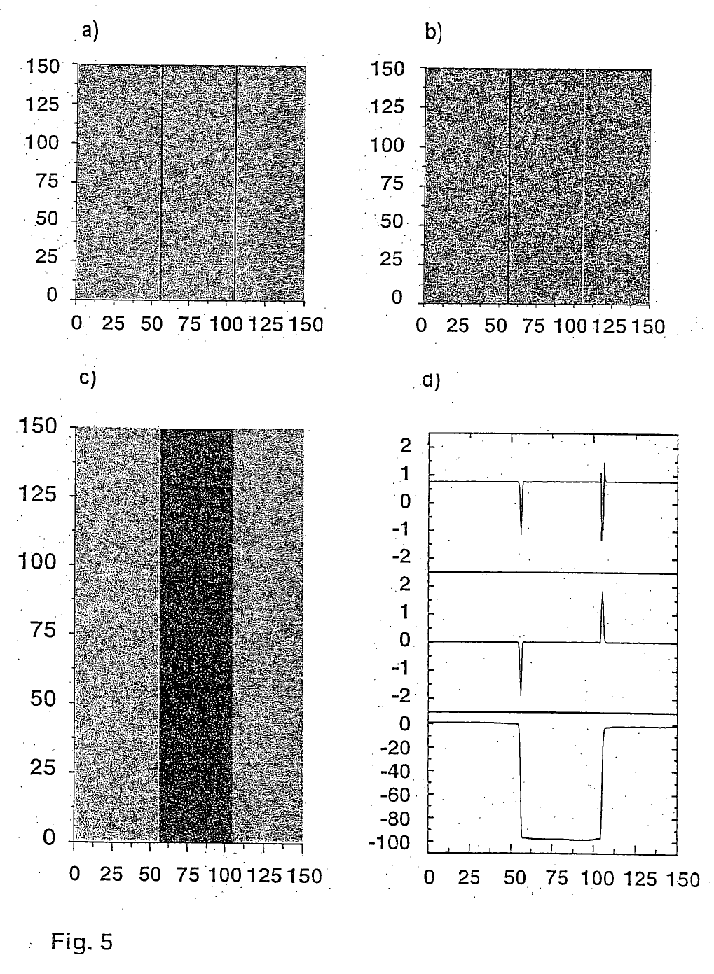

The result of the phase calculation for the 98.5 nm step height standard is shown in FIG. 5a). FIG. 5b) shows the corrected phase distribution, from which the surface topography may be reconstructed in FIG. 5c) by means of numeric integration. This, respectively, concerns a section of 450×450 image points in size in grey level representation, i.e. the brightness of an image point is proportional to its elevation “x” is entered to the right and “y” upwards, respectively, in gm. For clearer illustration FIG. 5d) respectively shows the bottom line of the grey level representations from FIGS. 5a), b) and c) as a one-dimensional profile. Again, x is recorded in μm to the right, but z is recorded upwards in nm.

The two edges of the step are clearly evident in FIG. 5a) as dark fringes, the right-hand dark fringe having a weak bright edge. The one-dimensional profile of the phase in FIG. 5d) clearly indicates the difference between the two fringes. The bright edge of the second fringe is attributable to the convolution of the phase in the value range of between −π and π. For a quantitative evaluation the phase distribution from FIG. 5a) is to be corrected by firstly unwrapping it and then subjecting it to a linear regression.

For unwrapping, multiples of π are added to or subtracted from the phase value of an image point until the phase difference from the preceding image point is less than π/2. A linear regression is then performed for each line and the result of this is then subtracted from the respective line. In this case, the linear phase increase and phase offset are removed. The result of the phase distribution corrected in this manner is shown in FIG. 5b). The negative and positive change in elevation at the edges of the step are clearly evident as black and as white fringes, whereas the rest of the image is uniformly grey. The one-dimensional profile of the corrected phase distribution in FIG. 5d) clarifies the corrections with respect to the original phase distribution. The phase components lie symmetrically to the x axis. The negative and positive changes in elevation at the step edges are of equal value. This corrected phase distribution is the gradient image of the surface topography.

The numeric integration is performed along the x axis to reconstruct the surface topography from this gradient image. The result of the integration is shown as a grey level pattern in FIG. 5c). The 98.5 nm step is clearly visible as a black fringe. The one-dimensional profile of the step in FIG. 5d) clarifies the good reproduction of the surface topography along the x axis. The step has a depth of approximately 100 nm with a width of 50 μm.

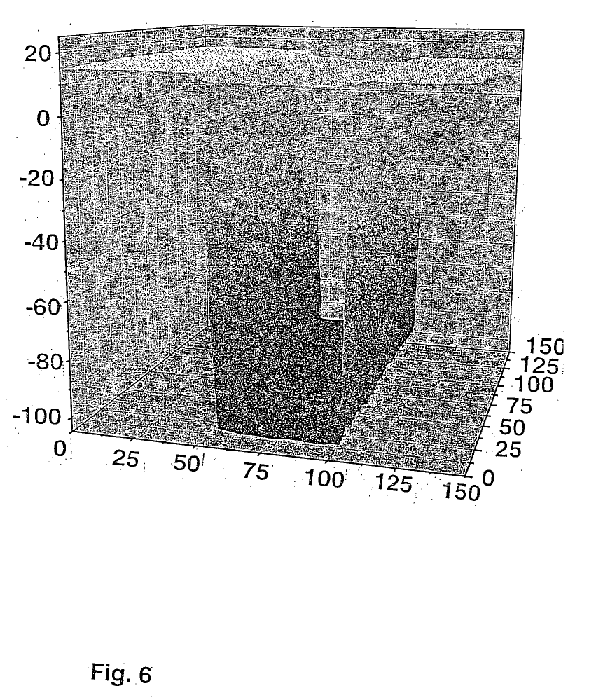

The software used also permits three-dimensional visualisation of the measurement data in addition to the grey level representations. FIG. 6 shows the surface topographies of the 98.5 nm and 2.7 nm step of the step height standard superposed. The two steps were oriented perpendicular to the shear direction to enable measurement of their actual depth. The representation of the 2.7 nm deep step was raised 15 nm for a clearer view. The image section has an edge length of 150 μm×150 μm. x and y are again recorded in μm, to the right or optically rearwards, while z is recorded in nm upwards. In spite of the lacking elevation information along the y axis, a very realistic image of the surface topography results. The 2.7 nm step is also very well resolved.

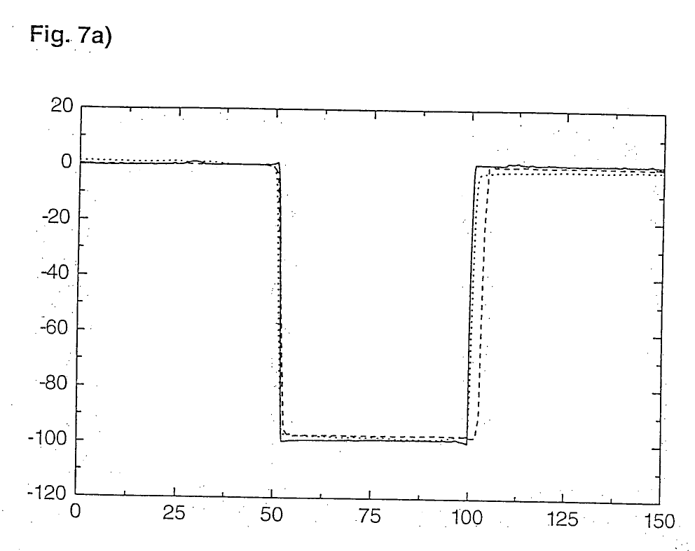

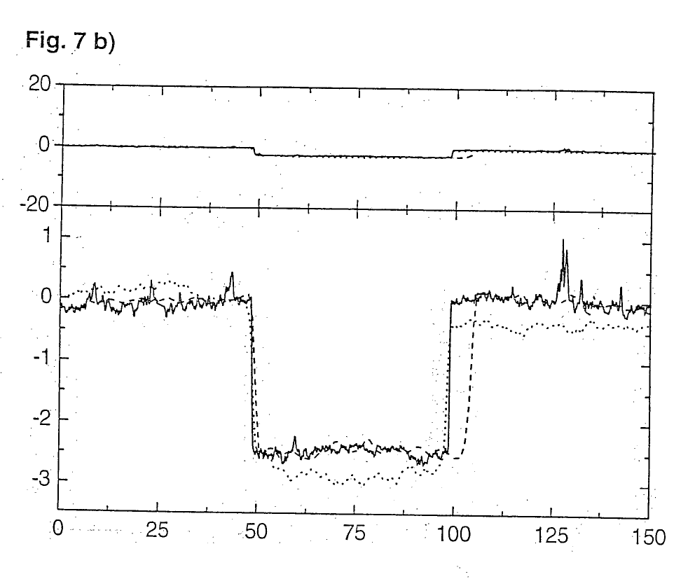

A comparison with other known measurement devices is beneficial for checking the results. For this, FIG. 7 compares the results of step measurements for two step height standards using the mechanical profilometer (MP) shown as a solid line, the optical heterodyne profilometer (OHP) as a broken line, and the Nomarski microscope according to the invention (NM) as a dotted line. Three surface profiles of the 98.5 nm step are shown in FIG. 7a). For comparison, FIG. 7b) shows three surface profiles of the 2.7 nm step on two difference scales: true to scale to the 98.5 nm step and greatly magnified in the upper representation. Again, x is entered in μm to the right and z in nm upwards.

Taking into consideration the fact that the surface profile was measured at different areas of the seam, the consistency of the measurement results with respect to the depth and the width of the step is excellent. The optical heterodyne profilometer is an exception. Because of its measurement principle, in which the measured values lie on a circle, it is not capable of correct determination of the step width. Moreover, in the greatly magnified representation of the 2.7 nm step, a sinusoidal deviation of the results of the Nomarski microscope from the results of the two other measurement instruments is visible. This is a typical error for phase shifting interferometry, which is attributable to small deviations in the adjustment of the phase shift. It has an amplitude of few tenths of nanometres with a solid spatial wavelength of about 150 μm. This error should be corrected for determination of roughness values of super-smooth surfaces. Because of its fixed spatial wavelength, this can be achieved by Fourier filtering, in which components with this spatial wavelength are filtered out of the surface profile.

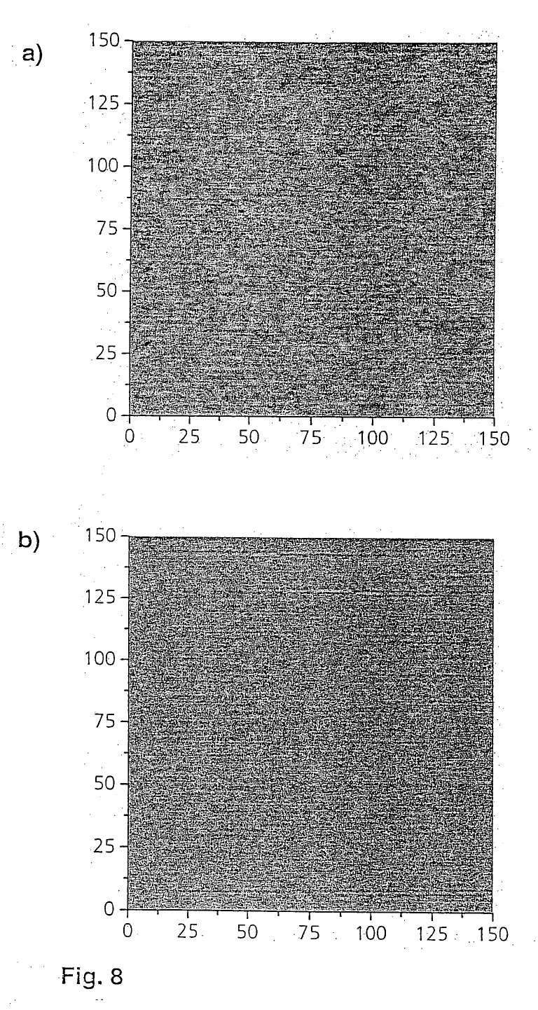

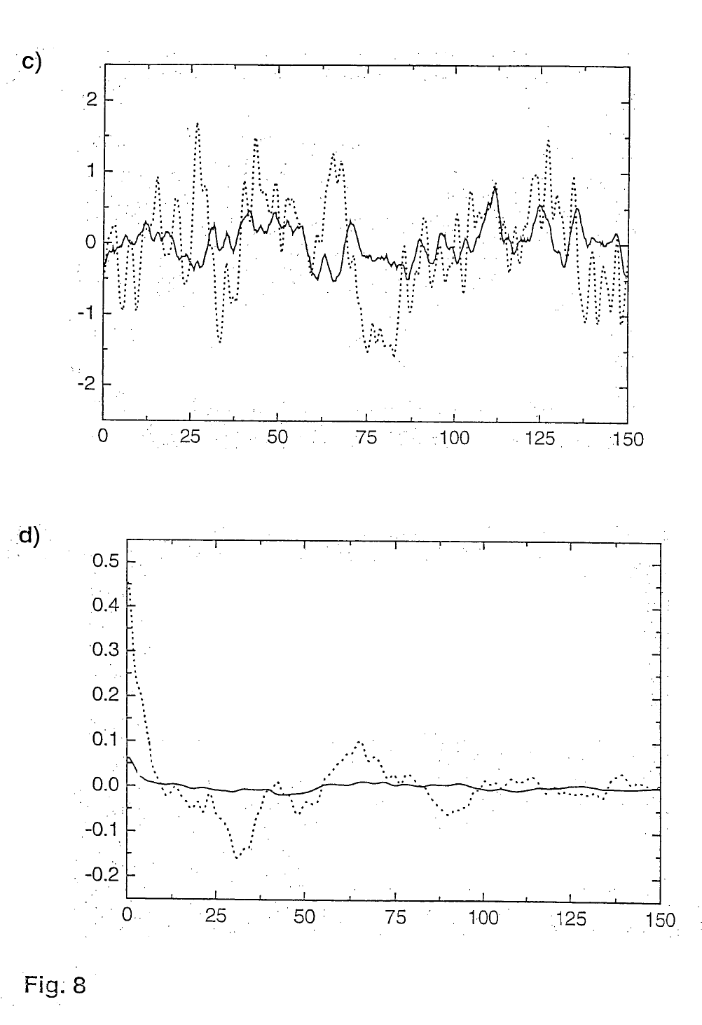

For demonstration of the suitability of the device for roughness measurements and further statistical roughness parameters, two BK7 substrates have been selected, by way of example, which have been given the references 0135 (respectively shown as a dotted line) and 0312 (respectively shown as a solid line). The results of the roughness measurement are summarised in FIG. 8. “x” and y are recorded in um to the right and upwards respectively, and z in nm upwards in FIG. 8a). The adjustments of the various measurements were
a) R_{q}(OHP)=0.82 nm, l_{c}=5 μm R_{q}(NM)=0.67 nm, l_{c}=4.33 μm
b) R_{q}(OHP)=0.24 nm, l_{c}=9 μm R_{q}(NM)=0.25 nm, l_{c}=3.33 μm

The same scale was selected for the grey level representation of the two surfaces in FIGS. 8a) and b), i.e. black corresponds to a z value of −6 nm and white to a z value of +6 nm. As a result, the different roughness of the two samples is made clear in the grey level representation. Both representations have stripes in the x direction, from which the absence of elevation information along the y axis becomes clear. The greater roughness of sample 0135 compared to sample 0312 is particularly clear from the one-dimensional surface profiles in FIG. 8c). The auto-covariance functions calculated from the two surface profiles are compared in FIG. 8d). In FIG. 8d) is recorded in μm to the right and c (τ) in nm² upwards. According to this, sample 0135 has a mean square roughness of 0.67 nm with a correlation length of 4.33 μm compared to a mean square roughness of 0.25 nm and a correlation length of 3.33 μm in sample 0312. These results confirm the measured values for the mean square roughness determined with the optical heterodyne profilometer (OHP). In this case, the consistency of the results of the Nomarski microscope (NM) according to the invention and the optical heterodyne profilometer for the determined mean square roughness R_{q} on BK7 substrate 0312 can be determined as very good. However, with this substrate severe differences, approximately factor three, result for the correlation length l_{c} between the two measurement instruments. In the case of BK7 substrate 0135, the results of the two measurement instruments for R_{q} and l_{c} deviate 20% and 15% respectively from one another.

The deviations between the two measurement devices are attributable firstly to the fact that the measurements were conducted on different areas on the sample surface. Secondly, the two measurement devices are distinguished by different band boundaries, which lead to systematic deviations of the measurement results from one another.

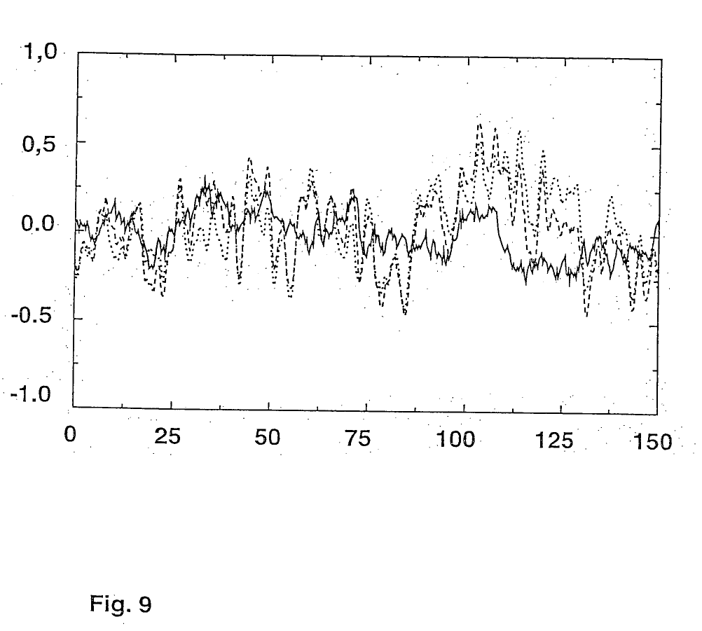

The determination of the minimum vertical resolution serves to determine the repetitive accuracy. For this, the smoother BK7 sample 0312 from FIG. 8b) was used. Two roughness measurements were performed one after the other on the same location on the surface. FIG. 9 shows two one-dimensional surface profiles of these two measurements. x is recorded in μm to the right and z in nm upwards. The individual measurements are shown as a broken line (measurement I where R_{q}=0.22 nm) or as a dotted line (measurement II where R_{q}=0.21 nm), and the difference as a solid line.

The deviations between the two individual measurements are clearly evident. The difference in the two individual measurements has a mean square roughness of 0.12 nm. This repetitive accuracy reflects the signal-to-noise ratio of the CCD sensor. The optical resolution of the microscope is better, since the microscope also reproduces structures of surface topographies with roughness values of 0.05 nm on viewing with the human eye.

In a further embodiment of the invention, the rotational axis of the CCD sensor is centred relative to the rotational axis of the sample support, i.e. the support of the work piece 10. Two measurements can then be performed on the work piece 10, which is rotated respectively 90° around the optical axis of the microscope in order to detect surface structures running both in the x and the y directions. By superposition of the two line profiles, a complete image of the surface 11 of the work piece 10 can then be determined.

In the case of axes of the CCD sensor and the support of the work piece 10 which are not sufficiently well centred, a further embodiment can be applied, in which case the displacement of the image section after 90° displacement is determined by image comparison techniques.

It will be understood that various modifications may be made to the embodiment disclosed herein. Therefore, the above description should not be construed as limiting, but merely as exemplifications of a preferred embodiment. Those skilled in the art will envision other modifications within the scope, spirit and intent of the invention.

What is claimed is:

1. A microscope for the quantitative optical measurement of a topography of a surface of a work piece,
comprising:
a Nomarski-type differential interference contrast microscope having a light source, a polariser, a Nomarski prism and an analyser said light source constructed and arranged to provide a narrow frequency spectrum,
device constructed and arranged to produce a reproducible phase shifting;
and a phase shifting interferometry evaluation unit;
wherein the microscope further comprises a module unit, the module unit including the adjustable Nomarski prism and the device constructed and arranged to product the reproducible phase shifting, the module unit being constructed and arranged to be insertable interchangeably into the optical path of a conventional microscope.

2. The apparatus according to claim 1,
wherein
the evaluation unit includes an electro-optical image converter.

3. The apparatus according to claim 1,
wherein
the device constructed and arranged to produce a reproducible phase shifting includes a mechanism constructed and arranged to displace the Nomarski prism.

4. (cancel)

5. The apparatus according to claim 3,
wherein
the device constructed and arranged to produce a reproducible phase shifting is reproducibly adjustable by a controllable element.

6. (cancel)

7. The apparatus according to claim 1,
wherein
the module is rotatable about the optical axis.

8. The apparatus according to claim 1, further comprising a work piece support member,
wherein
the rotational axis of the support member is centered relative to an optical axis of the microscope.

9. The apparatus according to claim 8,
wherein
the centering occurs with a precision below a limit resolution of the microscope.

10. A method of quantitative optical measurement of the topography of a surface of a work piece,
comprising the steps of:
conducting a Nomarski-type differential interference contrast method; working a light from a narrow frequency spectrum; and automatically conducting an evaluation by means of a microprocessor controlled phase shifting interferometry unit.

11. The method according to claim 10,
wherein the evaluation is conducted by
phase measurement interferometry (PMI), the evaluation algorithm of which is independent of background brightness or an uneven brightness distribution.

12. The method according to claim 11,
wherein
the phase is shifted in steps between about 0 and π, preferably by about π/2, and
wherein intensity is measured in consecutive measurements.

13. The method according to claim 11,
wherein
the phase is continuously shifted and intensity is integrated.

14. The method according to claim 10,
further comprising the steps of: conducting
a calibration of the phase shift;
a recording image brightness as a function of a position of a Nomarski prism,
and evaluating according to a theoretical model for the brightness curve.

15. The method according to claim 10,
wherein the evaluation by means of phase shift interferometry occurs by means of an unfolding operation.

16. The method according to claim 15,
wherein
the unfolding operation includes adding or subtracting multiples of π to the phase value of an image point until the phase difference is smaller than about π/2, and subsequently conducting a linear regression for each line, the result of which is subtracted from the respective line.

17. The method according to claim 15,
wherein
for reconstruction of the topography of the surface of the work piece, an acquired unfolded image is integrated.

18. The method according to claim 10,
further comprising the steps of:
providing the rotational axis of a sensor in the evaluation unit centred relative to a rotational axis of the support of the work piece,
conducting at least two measurements on the work piece rotated by an angle around the optical axis relative to the sensor,
and conducting a superposition and/or calculation of at least one line profile in two directions for spatial coverage of surface structures.

19. The method according to claim 18,
wherein
precisely two measurements are conducted on the work piece rotated 90° around the optical axis relative to the sensor.

20. The apparatus of claim 2, wherein the image converter is selected from the group consisting of a camera and a CCD sensor.

21. (cancel)

22. The apparatus of claim 1, wherein the Nomarski prism is displaceable.

23. The apparatus according to claim 1, wherein the light source further includes a spectral filter with a narrow frequency spectrum.

24. (cancel)

25. A microscope for the quantitative optical measurement of a topography of a surface of a work piece, comprising:
a Nomarski-type differential interference contrast microscope having a light source including a spectral filter, a polariser, a Nomarski prism and an analyser, the spectral filter being constructed and arranged to provide a narrow frequency spectrum;
a device constructed and arranged to produce a reproducible phase shifting; and
a microprocessor controlled phase shifting interferometry evaluation unit.

26. The microscope of claim 1, wherein the light source is equipped with a spectral filter constructed and arranged to provide a narrow frequency spectrum.

27. A microscope for the quantitative optical measurement of a topography of a surface of a work piece, comprising:
a Nomarski-type differential interference contrast microscope having a light source, a polarizer, a Nomarski prism and an automatically rotatable analyzer, said light source being constructed and arranged to provide a narrow frequency spectrum;
a device constructed and arranged to produce a reproducible phase shifting; and
a phase shifting interferometry evaluation unit;
wherein the microscope further comprises an interchangeable module unit including the analyzer and a λ/4 plate in the optical path, said module unit being insertable interchangeably into the optical path of a conventional microscope.

28. The microscope of claim 27, wherein said light source further comprises a spectral filter constructed and arranged to provide a narrow frequency spectrum.

29. The apparatus according to claim 27, wherein the device constructed and arranged to produce reproducible phase shifting has a λ/4 plate in the optical path.
